(19) United States
(12) Patent Application Publication
(10) Pub. No.: US 2026/0149779 A1
(43) Pub. Date: May 28, 2026

(54) IMAGE READING APPARATUS AND IMAGE FORMING SYSTEM

(71) Applicant: Konica Minolta, Inc., Tokyo (JP)

(72) Inventor: Yoshito HASHIMURA, Kanagawa (JP)

(21) Appl. No.: 19/386,362

(22) Filed: Nov. 12, 2025

(30) Foreign Application Priority Data
Nov. 22, 2024 (JP) 2024-203807

(51) Int. Cl. H04N 1/00

(52) U.S. Cl. CPC H04N 1/00647; H04N 1/00588; H04N 1/00602; H04N 1/00615

(57) ABSTRACT

Provided is an image reading apparatus including: a reader that reads an image formed on a recording medium; a conveyor that conveys the recording medium toward a reading region in which the reader reads the image, where the conveyor includes a conveyance roller pair disposed on a downstream side of the reading region; and an air flow generator that generates an air flow flowing from the reading region toward the conveyance roller pair.

### CROSS REFERENCE TO RELATED APPLICATIONS

The entire disclosure of Japanese patent Application No. 2024-203807, filed on November 22, 2024, is incorporated herein by reference in its entirety.

### BACKGROUND

### 1 . Technological Field

The present invention relates to an image reading apparatus and an image forming system.

### 2. Description of the Related Art

In the related art, there is known an image reading apparatus that reads an image formed on a recording medium. For example, Japanese Patent Publication Laid-Open No. 2021-182686 discloses a configuration in which the occurrence of a jam in an image reading apparatus is suppressed by configuring a conveyance guide forming a part of a sheet conveyance path to be capable of performing retraction movement from a position defining the sheet conveyance path.

### SUMMARY

However, in the configuration described in Japanese Patent Publication Laid-Open No. 2021-182686, the posture of the recording medium cannot be stabilized in a case where the recording medium has been conveyed in a state in which the leading end of the recording medium passing through a reading region is deformed so as to float (curl deformation). For this reason, the above-described configuration has a certain limit as a configuration for suppressing the occurrence of a defect such as a jam.

An object of the present invention is to provide an image reading apparatus and an image forming system each capable of suppressing the occurrence of a defect during image reading.

In order to realize at least one of the above-described objects, an image reading apparatus reflecting one aspect of the present invention includes:

a reader that reads an image formed on a recording medium;

a conveyor that conveys the recording medium toward a reading region in which the reader reads the image, where the conveyor includes a conveyance roller pair disposed on a downstream side of the reading region; and

an air flow generator that generates an air flow flowing from the reading region toward the conveyance roller pair.

In order to achieve at least one of the above-described objects, an image forming system reflecting one aspect of the present invention includes:

an image forming apparatus that forms an image on a recording medium; and

the image reading apparatus described above that reads the image on the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming system including an image reading apparatus according to an embodiment of the present invention;

FIG. 2 is a diagram illustrating the image reading apparatus according to the present embodiment;

FIG. 3 is a top view of the image reading apparatus according to the present embodiment;

FIG. 4 is a diagram provided for describing an operation of an air flow generator;

FIG. 5 is a flowchart illustrating exemplary operations of image reading control at the image reading apparatus;

FIG. 6 is a diagram illustrating an air flow generator according to a variation; and

FIG. 7 is a diagram illustrating an air flow generator according to a variation.

### DETAILED DESCRIPTION OF EMBODIMENTS

Hereinafter, one or more embodiments of the present invention will be described with reference to the drawings. However, the scope of the invention is not limited to the disclosed embodiments.

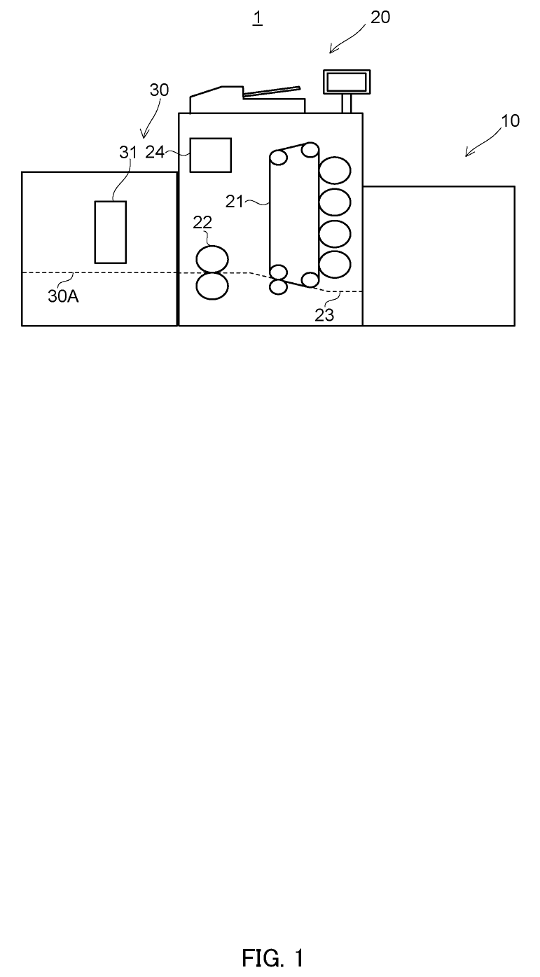

Hereinafter, an embodiment of the present invention will be described in detail with reference to the accompanying drawings. FIG. 1 is a diagram schematically illustrating an overall configuration of an image forming system 1 including an image reading apparatus 30 according to an embodiment of the present invention.

As illustrated in FIG. 1, the image forming system 1 is a system capable of forming an image by reading an image formed on a recording medium to be described later and executing image correction according to the read reading information of the recording medium. The image forming system 1 includes a sheet feed apparatus 10, an image forming apparatus 20, and the image reading apparatus 30.

The sheet feed apparatus 10 includes, for example, a plurality of stages of sheet feed units therein, and feeds recording media one by one to the image forming apparatus 20. In the sheet feed unit, recording media identified based on the basis weight, the size, and the like are housed.

The image forming apparatus 20 is, for example, a color image forming apparatus of an intermediate transfer method utilizing an electrophotographic process technology. Specifically, the image forming apparatus 20 primary-transfers toner images of colors of yellow (Y), magenta (M), cyan (C), and black (K) formed on photosensitive drums onto an intermediate transfer belt, superimposes the toner images of the four colors on one another on the intermediate transfer belt, and then secondary-transfers the resultant image onto a recording medium fed out from sheet feed tray units to form an image. Note that, the image forming apparatus 20 may be an image forming apparatus other than that of the intermediate transfer method.

The image forming apparatus 20 includes an image former 21, a fixer 22, a conveyor 23, a controller 24, and the like.

The controller 24 includes a central processing unit (CPU), a read only memory (ROM), a random access memory (RAM), and the like. The CPU reads a program according to the processing content from the ROM, develops the program in the RAM, and performs centralized control of the operation of each block and the like of the image forming apparatus 20 in cooperation with the developed program.

The image former 21 forms an image (toner image) on a recording medium fed from the sheet feed apparatus 10. The image former 21 includes image forming units for forming images with color toners of Y, M, C, and K components, an intermediate transfer unit, and the like.

The fixer 22 heats and pressurizes the conveyed recording medium, onto which the toner image has been transferred, at a fixing nip, thereby fixing the toner image on the recording medium.

The conveyor 23 includes a conveyance route, a sheet ejector, and the like. The conveyance route includes a plurality of conveyance roller pairs such as a registration roller pair, a normal conveyance path along which the recording medium is passed through the image former 21 and the fixer 22 and is ejected to the outside of the image forming apparatus 20, and the like.

Recording media housed in the sheet feed apparatus 10 are fed out one by one starting from the uppermost recording medium and are conveyed to the image forming apparatus 20. The recording medium that has been conveyed to the image forming apparatus 20 is conveyed to the image former 21 by the conveyance route. At the image former 21, the toner images on the intermediate transfer belt are collectively secondarily-transferred onto one surface side of the recording medium, and a fixing process is performed at the fixer 22. The recording medium on which an image has been formed is ejected to the outside of the apparatus by the sheet ejector including sheet ejection rollers, and is conveyed to the image reading apparatus 30.

The image reading apparatus 30 is an apparatus for reading an image formed on a recording medium conveyed from the image forming apparatus 20. The image reading apparatus 30 is provided with a conveyance route 30A connected to a sheet ejection port of the image forming apparatus 20.

The image reading apparatus 30 feeds back image information (for example, colorimetric information) of the recording medium read by a reader 32, which will be described later, to the image forming apparatus 20 via a communicator (not illustrated). Thus, the controller 24 of the image forming apparatus 20 performs image correction on the image formation condition(s) at the image former 21 according to the read information of the recording medium. The method of the image correction may be, for example, a technique known in the art.

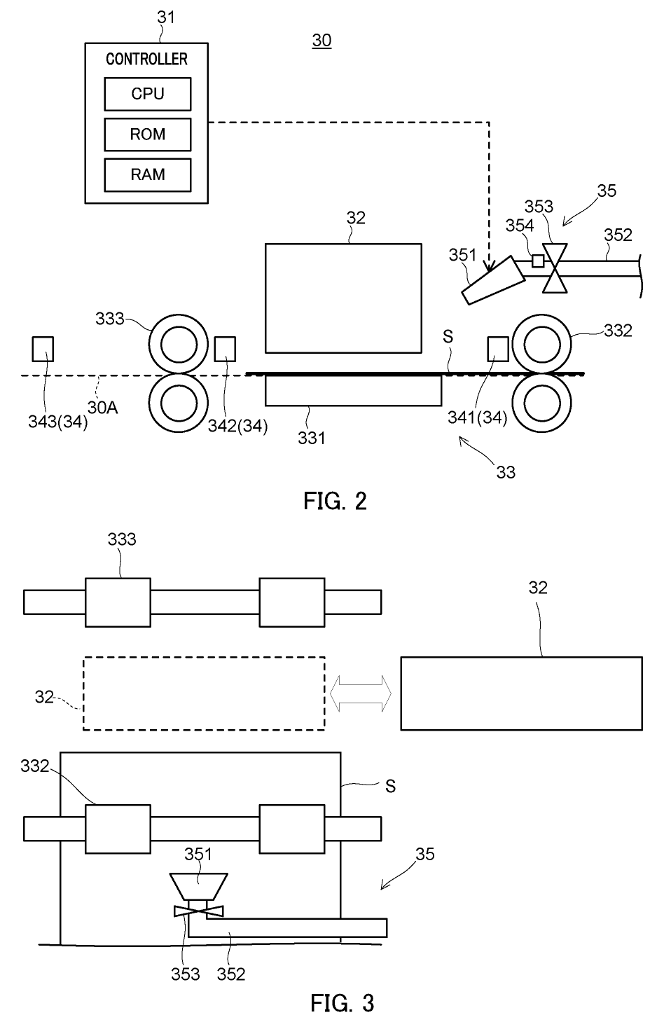

As illustrated in FIG. 2, the image reading apparatus 30 includes a controller 31, the reader 32, a conveyor 33, a sensor section 34, and an air flow generator 35.

The controller 31 includes a central processing unit (CPU), a read only memory (ROM), a random access memory (RAM), and the like. The CPU reads a program according to the processing content from the ROM, develops the program in the RAM, and performs centralized control of the operation of each block and the like of the image reading apparatus 30 in cooperation with the developed program.

The reader 32 is, for example, a colorimeter, and is disposed so as to be capable of reading color information of a recording medium S conveyed to the conveyance route 30A.

Further, as illustrated in FIG. 3, the reader 32 is configured to be movable between a first position and a second position.

The first position is a position at which the reader 32 is disposed to face a reading region (the position indicated by the broken line in FIG. 3).

The reading region is a region in which a reading operation is performed by the reader 32, and is located on the conveyance route 30A. The reading region is, for example, a region corresponding to a leading end portion of an image forming region of the recording medium S when the leading end portion of the recording medium S on the conveyance route 30A has reached a conveyance nip at a second conveyance roller pair 333 to be described later.

The second position is a position at which the reader 32 is not disposed to face the reading region, and is, for example, a position retracted from the first position in the width direction of the conveyance route 30A (the position indicated by the solid line in FIG. 3).

The position at which the reader 32 is disposed is switched under the control of the controller 31 such that the reader 32 is located at the first position when the reading operation is performed and is located at the second position when the reading operation is not performed.

As illustrated in FIG. 2, the conveyor 33 conveys the recording medium S toward the reading region in which the reader 32 performs the reading operation, and includes a guide 331, a first conveyance roller pair 332, and the second conveyance roller pair 333.

The guide 331 guides the conveyance of the recording medium S on the conveyance route 30A, and is disposed, at a position facing the reader 32 at the first position, along the conveyance direction of the recording medium S.

The first conveyance roller pair 332 is a roller pair that conveys the recording medium S, and is disposed on the upstream side of the guide 331 in the conveyance direction of the recording medium S.

The second conveyance roller pair 333 is a roller pair that conveys the recording medium S, and is disposed on the downstream side of the guide 331 in the conveyance direction of the recording medium S. The second conveyance roller pair 333 corresponds to the “conveyance roller pair” in the present invention.

The sensor section 34 represents sensors that detect the recording medium S on the conveyance route 30A, and includes a first sensor 341, a second sensor 342, and a third sensor 343. The first sensor 341, the second sensor 342, and the third sensor 343 are, for example, sensors known in the art.

The first sensor 341 is a sensor for detecting that the leading end portion of the recording medium S has passed through the first conveyance roller pair 332, and is disposed, on the downstream side of a conveyance nip at the first conveyance roller pair 332, at a position in the vicinity of the conveyance nip.

The second sensor 342 is a sensor for detecting that the leading end portion of the recording medium S has reached the second conveyance roller pair 333, and is disposed, on the upstream side of the conveyance nip at the second conveyance roller pair 333, at a position in the vicinity of the conveyance nip.

The third sensor 343 is a sensor for detecting that the rear end portion of the image forming region of the recording medium S has passed through the reading region of the reader 32, and is disposed on the downstream side of the conveyance nip at the second conveyance roller pair 333.

The air flow generator 35 generates an air flow for correcting the posture of the leading end portion of the recording medium S, and includes a nozzle 351, an air supply pipe 352, a valve 353, and a detector 354.

The nozzle 351 is a portion constituting an air blowing-out port for blowing an air flow onto the recording medium S, and is connected to the air supply pipe 352.

The air supply pipe 352 supplies air to a portion of the nozzle 351, and is connected to a tank (not illustrated) or the like that makes it possible to supply an air flow.

The valve 353 is configured to be capable of opening and closing the air supply pipe 352, and is provided at the air supply pipe 352.

The detector 354 is, for example, a flowmeter, a pressure gauge, or the like that is capable of detecting the generation of an air flow, and is provided in the vicinity of the valve 353 of the air supply pipe 352. The presence of the detector 354 makes it possible to accurately detect the presence or absence of the generation of an air flow.

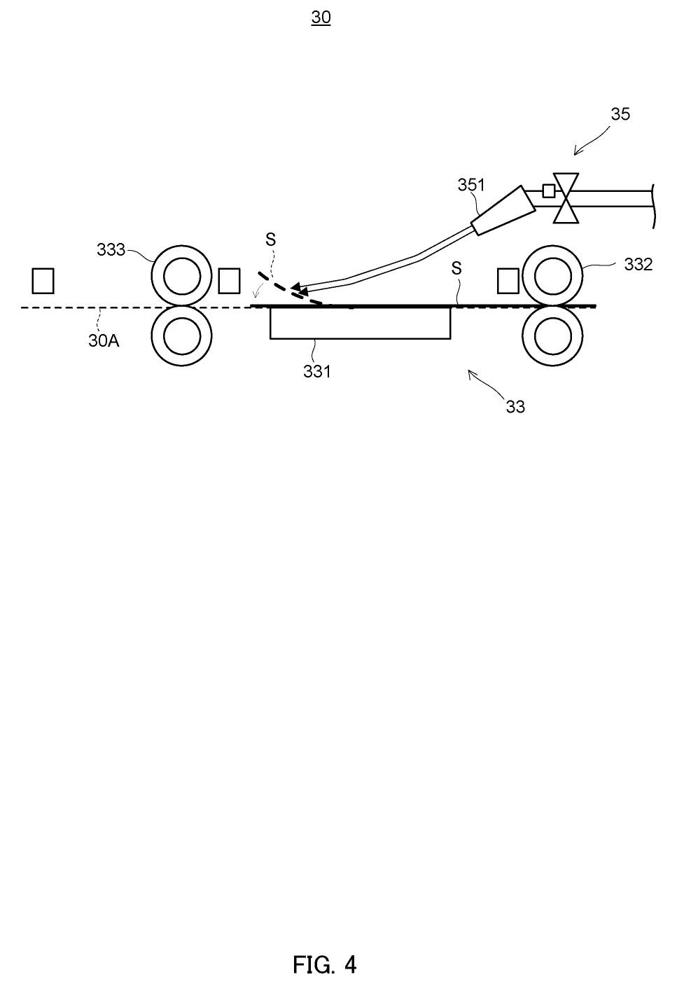

As illustrated in FIG. 4, the air flow generator 35 is disposed on the upstream side of the reader 32 at the first position in the conveyance direction (outside the movement range of the reader 32) so as to generate an air flow flowing from the reading region toward the second conveyance roller pair 333. More specifically, the air flow generator 35 generates an air flow flowing from the upstream side of the reading region toward the downstream side of the reading region.

Specifically, the air flow generator 35 generates an air flow flowing toward the conveyance nip at the second conveyance roller pair 333 such that the leading end portion of the recording medium S is directed toward the side of the conveyance route 30A.

In this way, even when the recording medium S has been conveyed to the image reading apparatus 30 in a state in which the leading end portion of the recording medium S is curled and deformed so as to float, the curl deformation can be corrected by the air flow.

In addition, in the image reading apparatus 30, a space in which an air flow is generated communicates with the outside of the image reading apparatus 30. For example, the periphery of the reader 32 may be an open space, and a hole for exhausting an air flow to the outside of the image reading apparatus 30 may be formed in the housing of the image reading apparatus 30. In addition, a duct or the like for discharging an air flow to the outside of the image reading apparatus 30 may be provided at a portion to which an air flow flows.

In this way, an air flow can be appropriately released to the outside of the image reading apparatus 30 without the air flow staying around the reader 32.

Next, operations at the image reading apparatus 30 will be described.

At the conveyor 33, intermittent conveyance of the recording medium S is performed. That is, when the reading operation is performed by the reader 32, the conveyor 33 stops the conveyance of the recording medium S which has not reached the reading region. Then, after the reading operation is completed, the conveyor 33 resumes the conveyance of the recording medium S.

Under the control of the controller 31, the air flow generator 35 stops the generation of an air flow during the reading operation, and generates an air flow based on the timing with which the conveyance of the recording medium S has been resumed. That is, the air flow generator 35 switches between the generation of an air flow and the stop of the air flow based on the timing of the conveyance in the intermittent conveyance and based on the timing of stopping the conveyance in the intermittent conveyance.

Specifically, the air flow generator 35 starts the generation of an air flow based on a detection result of the first sensor 341, and stops the air flow based on a detection result of the second sensor 342. In other words, under the control of the controller 31, the air flow generator 35 starts the generation of an air flow based on the timing with which the leading end portion of the recording medium S has passed through the first conveyance roller pair 332. Then, under the control of the controller 31, the air flow generator 35 stops the air flow based on the timing with which the leading end portion of the recording medium S has reached the second conveyance roller pair 333.

In a case where there is no recording medium S in the vicinity of the reading region, it is not necessary to generate an air flow. In addition, in a case where the leading end portion of the recording medium S has reached the second conveyance roller pair 333, the deformation of the recording medium S has been corrected, and thus, it is not necessary to generate an air flow. For this reason, in the above-described manner, an air flow can be generated only at a necessary timing, and thus, the air flow generator 35 can be effectively used.

In addition, the controller 31 causes the reader 32 to be located at the second position in a case where an air flow is generated by the air flow generator 35, and causes the reader 32 to be located at the first position in a case where an air flow by the air flow generator 35 is stopped.

In this way, the reader 32 is located at the second position when an air flow is generated by the air flow generator 35. For this reason, it is possible to suppress the floated leading end portion of the recording medium S from interfering with the reader 32, it is possible to suppress the generated air flow from interfering with the reader 32, and further it is possible to suppress the occurrence of a jam in the vicinity of the reader 32.

In addition, in a case where the reader 32 is located at the first position and the reading operation is performed, there is a possibility that reading will be affected when an air flow is generated, and thus, the air flow is stopped in this case. As a result, the reading operation can be accurately performed.

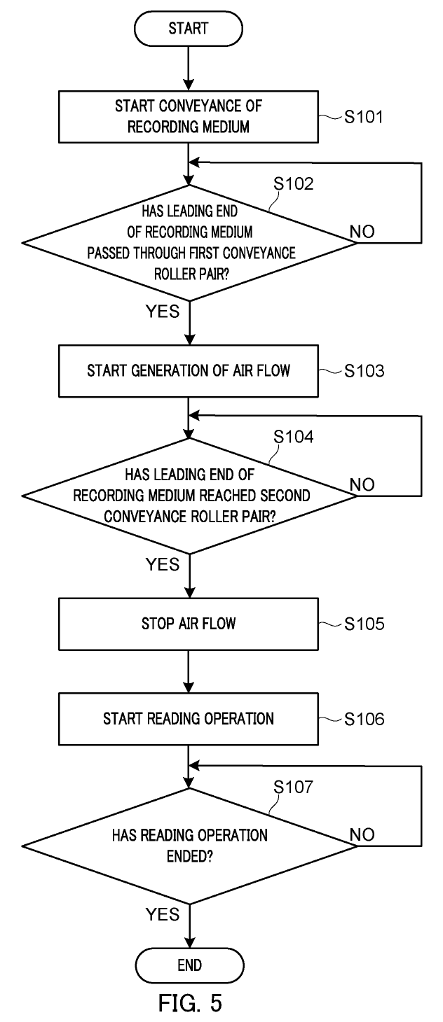

Exemplary operations of image reading control at the image reading apparatus 30 configured as described above will be described. FIG. 5 is a flowchart illustrating exemplary operations of image reading control at the image reading apparatus 30.

As illustrated in FIG. 5, the controller 31 causes the conveyance of the recording medium S to be started (step S101). Note that, at the reader 32, in a case where, when the recording medium S has been conveyed to the image reading apparatus 30, another recording medium had been conveyed to the image reading apparatus 30, the timing of starting the conveyance of the recording medium S may be a timing after the reading operation for the other recording medium has been performed. In addition, in a case where, when the recording medium S has been conveyed to the image reading apparatus 30, any other recording medium had not been conveyed to the image reading apparatus 30, the timing of starting the conveyance of the recording medium S may be the timing with which the recording medium S has been conveyed to the image reading apparatus 30.

After step S101, the controller 31 determines whether the leading end of the recording medium S has passed through the first conveyance roller pair 332 (step S102). The determination as to whether the leading end of the recording medium S has passed through the first conveyance roller pair 332 is performed based on a detection result of the first sensor 341.

As a result of the determination, in a case where the leading end of the recording medium S has not passed through the first conveyance roller pair 332 (step S102, NO), the processing in step S102 is repeated. In a case where the leading end of the recording medium S has passed through the first conveyance roller pair 332 (step S102, YES), on the other hand, the controller 31 causes the air flow generator 35 to start the generation of an air flow (step S103).

After step S103, the controller 31 determines whether the leading end of the recording medium S has reached the second conveyance roller pair 333 (step S104). The determination as to whether the leading end of the recording medium S has reached the second conveyance roller pair 333 is performed based on a detection result of the second sensor 342.

As a result of the determination, in a case where the leading end of the recording medium S has not reached the second conveyance roller pair 333 (step S104, NO), the processing in step S104 is repeated. In a case where the leading end of the recording medium S has reached the second conveyance roller pair 333 (step S104, YES), on the other hand, the controller 31 causes the air flow generator 35 to stop the air flow (step S105).

After step S105, the controller 31 causes the reader 32 to start the reading operation (step S106). After step S106, the controller 31 determines whether the reading operation by the reader 32 has ended (step S107). The determination as to whether the reading operation has ended is performed based on a detection result of the third sensor 343.

As a result of the determination, in a case where the reading operation has not ended (step S107, NO), the processing in step S107 is repeated. In a case where the reading operation has ended (step S107, YES), on the other hand, the present control ends.

According to the present embodiment configured as described above, the air flow generator 35 generates an air flow flowing from the reading region toward the second conveyance roller pair 333, and thus, in a case where the recording medium S has been conveyed with curl deformation, the curl deformation of the recording medium S can be corrected. As a result, it is possible to suppress the occurrence of a defect such as a jam due to deformation of the recording medium S.

In addition, since the reader 32 is movable between the first position and the second position, a portion corresponding to the reading region is opened when the reader 32 is located at the second position. For this reason, when the leading end of the recording medium S is curled and deformed, the degree of the floating of the leading end is likely to increase, and a defect such as a jam is likely to occur.

In the present embodiment, curl deformation of the recording medium S can be corrected by causing the air flow generator 35 to generate an air flow, and thus, it is possible to effectively suppress the occurrence of a defect even in a configuration in which a defect is likely to occur.

In addition, since the air flow generator 35 is located outside the movement range of the reader 32, it is possible to suppress interference between the reader 32, which moves from the second position to the first position, and the air flow generator 35.

In addition, since the air flow generator 35 generates an air flow flowing from the upstream side of the reading region toward the downstream side of the reading region, it is possible to easily correct curl deformation of the recording medium S.

In addition, since the air flow generator 35 generates an air flow flowing toward the conveyance nip at the second conveyance roller pair 333, the leading end portion of the recording medium S whose deformation has been corrected can be easily brought into the above conveyance nip.

In addition, since the air flow generator 35 stops an air flow based on the timing with which the leading end of the recording medium S has reached the second conveyance roller pair 333, it is possible to suppress unnecessary generation of an air flow.

In addition, since the air flow generator 35 switches between the generation of an air flow and the stop of the air flow based on the timing of the conveyance in the intermittent conveyance and based on the timing of stopping the conveyance in the intermittent conveyance, it is possible to generate an air flow only at a necessary timing, and thus, it is possible to effectively use the air flow generator 35.

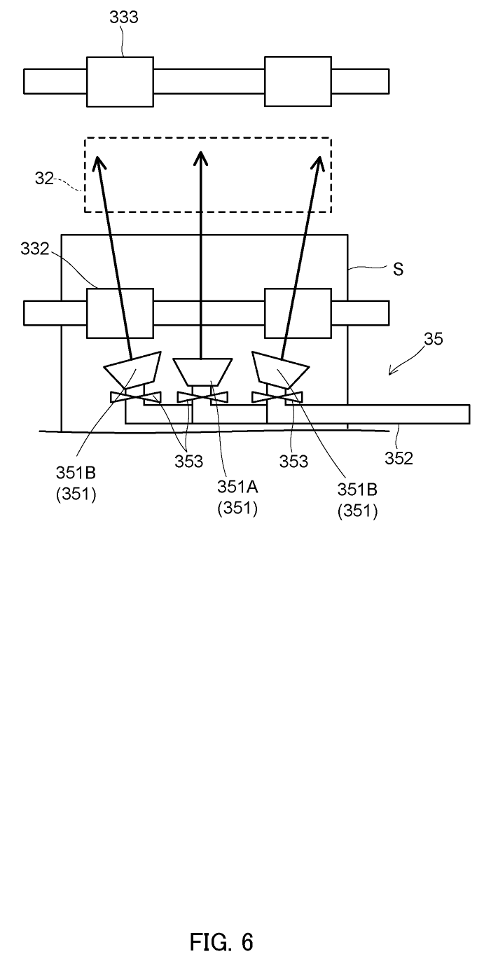

Note that, in the embodiment described above, it has been only described that an air flow flows from an upstream side toward a downstream side in the conveyance direction of the recording medium, and it has not been described how an air flow flows in the width direction of the recording medium S. For example, the air flow generator 35 may generate an air flow flowing from the center of the recoding medium S in the width direction of the recording medium S toward an end of the recording medium S in the width direction as illustrated in FIG. 6.

In this configuration, for example, the air flow generator 35 includes three nozzles 351. The three nozzles 351 are arranged side by side in the width direction of the recording medium S. The air supply pipe 352 is connected to each of the three nozzles 351, and one valve 353 is provided at a portion corresponding to each nozzle 351.

At a first nozzle 351A in the center among the three nozzles 351, an air flow flowing parallel to the conveyance direction is generated. At each of second nozzles 351B on the both sides of the first nozzle 351A, an air flow is generated which flows toward an end of the recording medium S opposite to the first nozzle 351A.

In this way, an air flow spreads the recording medium S from the inside thereof toward the outside thereof, and thus, it is possible to suppress the occurrence of wrinkles at the recording medium S while correcting curl deformation of the recording medium S.

In addition, although an air flow is generated regardless of the type of the recording medium S in the embodiment described above, the present invention is not limited thereto. For example, the controller 31 may adjust the flow rate of an air flow of the air flow generator 35 according to the type of the recording medium S. The controller 31 corresponds to an “adjuster” in the present invention.

For example, in a case where the flow rate of an air flow for the recording medium S having a predetermined thickness is set to a predetermined flow rate, the controller 31 causes the flow rate of the air flow to be larger than the predetermined flow rate when the recording medium S has a thickness thinner than the predetermined thickness. In addition, the controller 31 causes the flow rate of the air flow to be smaller than the predetermined flow rate when the recording medium S has a thickness thicker than the predetermined thickness.

In a case where the thickness of the recording medium S is thin, a defect such as curl deformation and wrinkles is likely to occur, and thus, it is possible to easily suppress the occurrence of a defect by increasing the flow rate of an air flow. In addition, in a case where the thickness of the recording medium S is thick, the above-described defect is unlikely to occur, and thus, it is possible to reduce unnecessary generation of an air flow by reducing the flow rate of an air flow.

In addition, in a case where the thickness of the recording medium S is thick, there is also a possibility that the above-described defect will not occur in the first place. Accordingly, in a case where the thickness of the recording medium S is thicker than the predetermined thickness, the controller 31 may cause an air flow to be stopped. In other words, the controller 31 may cause an air flow of the air flow generator 35 to be stopped according to the type of the recording medium S.

In addition, the controller 31 may change the range of an air flow of the air flow generator according to the width of the recording medium S. The controller 31 corresponds to a “changer” in the present invention.

For example, in a case where the width of the recording medium S is equal to or less than a predetermined width in the configuration illustrated in FIG. 6, the controller 31 causes an air flow to be generated only from the first nozzle 351A. In addition, in a case where the width of the recording medium S is larger than the predetermined width, the controller 31 causes an air flow to be generated from both the first nozzle 351A and the second nozzles 351B.

When air flows are generated from all the nozzles 351, an air flow that does not hit the recording medium S would be generated depending on the width of the recording medium S, but in the above-described manner, it is possible to suppress the generation of an air flow that does not hit the recording medium S.

In addition, although the air flow generator 35 is fixed in the embodiment described above, the present invention is not limited thereto. The air flow generator 35 may be configured to be movable.

For example, the air flow generator 35 may be configured to be movable between a position overlapping the reader 32 at the first position and a position retracted from the position overlapping the reader 32 at the first position.

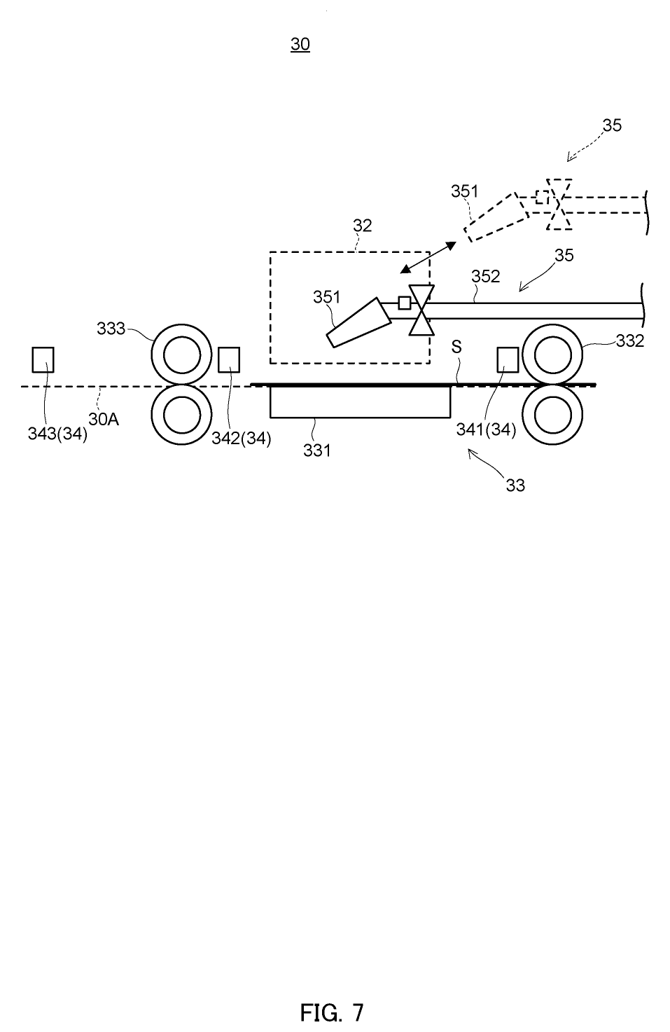

For example, as illustrated in FIG. 7, the air flow generator 35 is located at a position (the position of the solid line) closer to the recording medium S when the reader 32 is located at the second position, whereas the air flow generator 35 moves so as to located at a position (the position of the broken line) retracted from the position, which is closer to the recording medium S, when the reader 32 is located at the first position.

In this way, it is possible to easily cause an air flow to hit the recording medium S and to suppress interference between the reader 32 and the air flow generator 35 when the recording medium S is read by the reader 32.

In addition, although the reader 32 is movable between the first position and the second position in the embodiment described above, the present invention is not limited thereto and the reader 32 may be immovable. In this case, the air flow generator 35 may be configured to generate an air flow such that the air flow passes between the reader 32 and the conveyance route 30A.

In addition, in the embodiment described above, the reader 32 is a colorimeter that reads color information of an image formed on the recording medium S, but the present invention is not limited thereto. For example, the reader 32 may be, for example, a scanner or the like that reads information for detecting a defect in an image formed on the recording medium S.

In the image forming system 1, for example, information read by the reader 32 and information on the correct image may be compared with each other, and images that coincide with the correct image and images that do not coincide with the correct image may be sorted.

In addition, any of the embodiment described above is only illustration of an exemplary embodiment for carrying out the present invention, and the technical scope of the present invention shall not be construed limitedly thereby. That is, the present invention can be carried out in various forms without departing from the gist or the main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image reading apparatus, comprising:
a reader that reads an image formed on a recording medium;
a conveyor that conveys the recording medium toward a reading region in which the reader reads the image, the conveyor including a conveyance roller pair disposed on a downstream side of the reading region; and
an air flow generator that generates an air flow flowing from the reading region toward the conveyance roller pair.

2. The image reading apparatus according to claim 1, wherein
the reader is movable between a first position and a second position, the first position being a position at which the reader faces the reading region, the second position being a position at which the reader does not face the reading region.

3. The image reading apparatus according to claim 2, wherein
the air flow generator is located outside a movement range of the reader.

4. The image reading apparatus according to claim 2, wherein
the air flow generator is movable between a position overlapping the reader at the first position and a position retracted from the position overlapping the reader.

5. The image reading apparatus according to claim 1, wherein
the air flow generator generates the air flow flowing from an upstream side of the reading region toward the downstream side of the reading region.

6. The image reading apparatus according to claim 1, wherein
the air flow generator generates the air flow flowing toward a conveyance nip at the conveyance roller pair.

7. The image reading apparatus according to claim 1, wherein
the air flow generator generates an air flow flowing from a center of the recording medium in a width direction of the recording medium toward an end of the recording medium in the width direction.

8. The image reading apparatus according to claim 1, wherein
the air flow generator includes a nozzle.

9. The image reading apparatus according to claim 1, wherein
the air flow generator stops the air flow based on a timing with which a leading end of the recording medium has reached the conveyance roller pair.

10. The image reading apparatus according to claim 1, further comprising a hardware processor that adjusts a flow rate of the air flow of the air flow generator according to a type of the recording medium.

11. The image reading apparatus according to claim 1, further comprising a hardware processor that changes a range of the air flow of the air flow generator according to a width of the recording medium.

12. The image reading apparatus according to claim 1, wherein
a space in which the air flow is generated communicates with an outside of the image reading apparatus.

13. The image reading apparatus according to claim 1, further comprising a detector that detects generation of the air flow.

14. The image reading apparatus according to claim 1, wherein:
the conveyor performs intermittent conveyance in which conveyance of the recording medium that has not reached the reading region is stopped during a reading operation by the reader and the conveyance of the recording medium is resumed after the reading operation is completed, and
the air flow generator switches between generation of the air flow and stop of the air flow based on a timing of the conveyance in the intermittent conveyance and based on a timing of stopping the conveyance in the intermittent conveyance.

15. The image reading apparatus according to claim 1, wherein
the reader reads color information of the image formed on the recording medium.

16. The image reading apparatus according to claim 1, wherein
the reader detects a defect in the image formed on the recording medium.

17. An image forming system, comprising:
an image forming apparatus that forms an image on a recording medium; and
the image reading apparatus according to claim 1, the image reading apparatus reading the image on the recording medium.

18. The image forming system according to claim 17, wherein
a hardware processor of the image forming apparatus performs image correction based on image information read by the image reading apparatus.
